(19) United States
(12) Patent Application Publication
(10) Pub. No.: US 2004/0198327 A1
(43) Pub. Date: Oct. 7, 2004

(54) Telecommunications call completion

(76) Inventors: Mavis Bates, Aurora, IL (US); William Jackson Bushnell, St. Charles, IL (US)

Correspondence Address: Werner Ulrich, 434 Maple St., Glen Ellyn, IL, 60137, US

(21) Appl. No.: 10/127,990

(22) Filed: Apr. 22, 2002

(51) Int. Cl. H04Q 7/20

(52) U.S. Cl. 455/414.1; 455/445

(57) ABSTRACT

Apparatus and a method for flexibly completing a call to one of several associated telephone stations or to voice mail, or to a paging system. When a call is received for a called party having called party location service, a database is accessed to determine the routing of this call. The routing can be a function of the caller's identification, the status of various telephone stations of the called party, and of specific requests made by the called party. Advantageously, calls are routed in conformance with the called party's wishes, the number of desired call completions that are not effected is reduced, and the number of undesired call completions is also reduced.

### TECHNICAL FIELD

This invention relates to methods and apparatus for enhancing telecommunications call completion.

Problem:

It has been estimated that only one telecommunications call in seven is completed in real time. Other calls that encounter “busy” are routed to voice mail or customer premises equipment answering machines are directed to cellular telephones which are not powered-up, or are simply not answered by telephone customers who do not wish to be disturbed; especially by telemarketers. In effect, the completion of telephone calls has been become a balance between the interest of people who do not wish to be disturbed and the interests of people trying to get in touch with others. Accordingly, Applicants believe that there is a problem in the present arrangements for completing telephone calls, especially to parties who have telephone stations at home, at the office, and a cellular phone, and who might further have telephone stations at vacation homes. Follow-me service, which allows customers to have calls to their telephone number forwarded to a new number when the customer arrives at the location of the new number, does not flexibly meet the needs of such customers.

Solution:

Applicants have carefully studied these problems, and have concluded that present arrangements for completing calls are overly complex and require excessive effort on the part of a called party to improve call completion rates. In accordance with Applicants' invention, which represents an advance over the teachings of the prior art, the present location of a called party or the preferred treatment (e.g., routing to voice mail) is automatically accomplished as a party moves from one of his/her telephones to another, or turns on his/her cellular mobile station; a database maintains a list of the possible telephone numbers where the called party can be reached, and this database is consulted whenever a call to the called party is detected; the database is updated with information indicating that a cellular station has been powered-on or powered-off, or that a particular telephone station is now in use, and should be the station to which telephone calls to the called party should be routed. Advantageously, calls are automatically routed to the station of the called party which is most likely to be attended by the called party.

In accordance with one feature of Applicants' invention, a default attribute is associated with each action that activates or deactivates a telephone station. Treatment other than the default treatment is provided by having the called party signal to the database that a pre-planned alternative (for example, automatic routing of all calls to voice mail) is to be substituted for the default routing. Advantageously, this arrangement allows a called party to control routing of calls to that party.

In accordance with another feature of Applicants' invention, the routing of calls can be affected by the caller's identification, e.g., telephone number. Thus, for example, it is possible to have calls from a small number of pre-selected telephone numbers completed to the present location of the called party and to have all other calls routed to voice mail.

In accordance with another feature of Applicants' invention, callers who know a special identification code may have their calls treated in accordance with a preferred treatment list, e.g., completed to the called party instead of being routed to voice mail. This is especially useful for emergency type calls to called parties who do not wish to be disturbed.

### BRIEF DESCRIPTION OF THE DRAWING(s)

FIG. 1 is a block diagram illustrating how data in a called party location server can be entered;

FIG. 2 is a block diagram illustrating how calls can be completed in accordance with the invention;

FIG. 3 is a data table showing data stored for a called party having the called party location server service;

FIG. 4 is a flow diagram illustrating the operation of entering data in the called party location server; and

FIG. 5 is a flow diagram illustrating the completion of calls in accordance with Applicants' invention.

### DETAILED DESCRIPTION

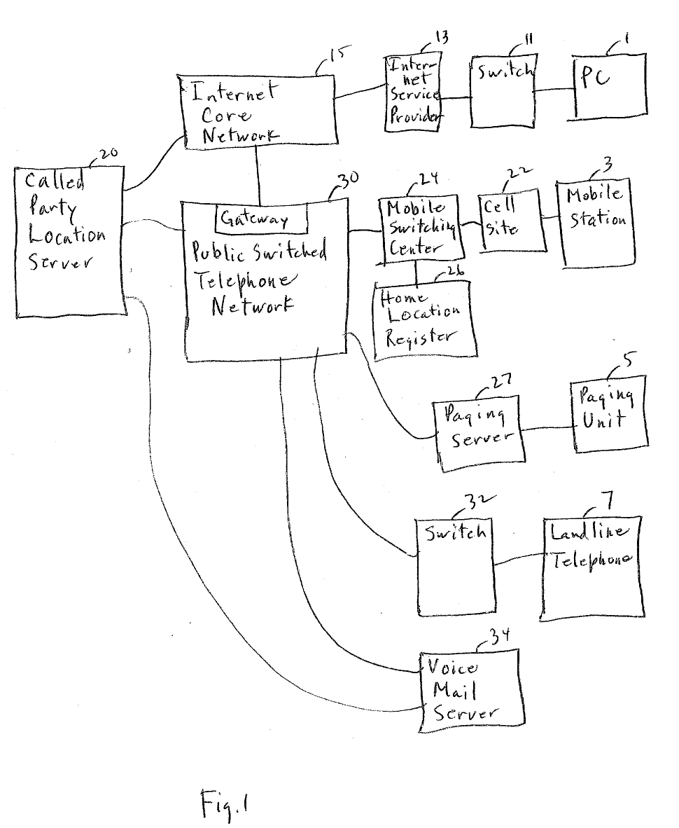

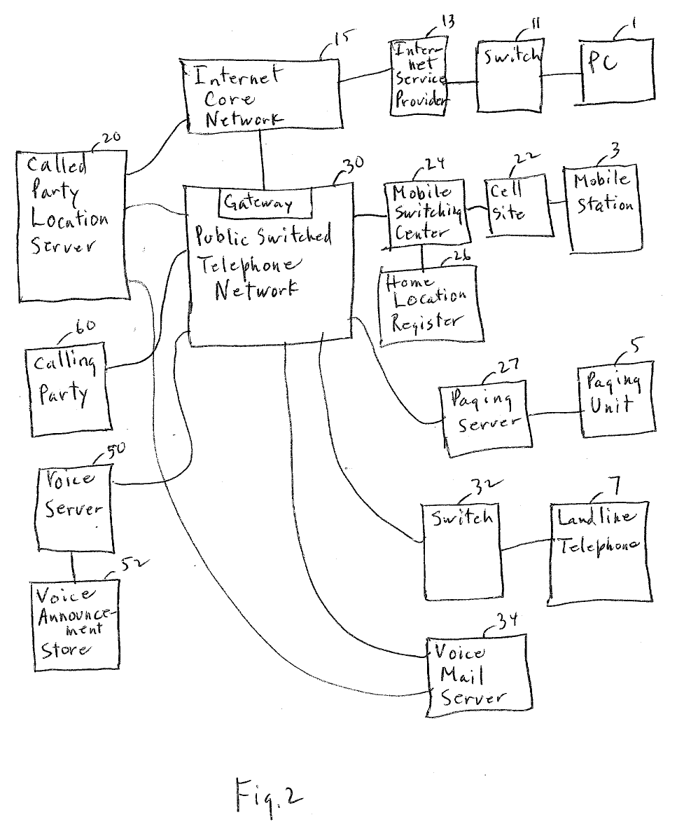

FIG. 1 is a block diagram illustrating the entry of data into a database, the called party location server (20). Among the stations served by this arrangement are a Personal Computer (1), a Mobile Station (3), a Paging Unit (5), and a Land-Line Telephone Station (7). The Personal Computer is connected through a Switch (11) to an Internet Service Provide (13). (If the Personal Computer is connected, for example, to a Digital Subscriber Line (DSL), then the PC is directly connected to the Internet Service Provider (13)). The Internet Service Provider is connected to the Internet Core Network (15), which has a connection to the Called Party Location Server (20). Mobile Station (3) is connected via Cell Site (22) to a Mobile Switching Center (24), having access to a Home Location Register (26). The Mobile Switching Center is connected to a Public Switched Telephone Network (30), which is connected to the Called Party Location Server (20). The Home Location Register (26) is adapted to recognize that the Mobile Station (3) has Called Party Location Server Service, and when the HLR (26) receives a registration message when the Mobile Station (3) is powered-on or powered-off the HLR transmits a data message to the Called Party Location Server indicating that Mobile Station (3) is now active or unavailable, respectively. The Paging Unit (5) is served by a Paging Server (27) which is connected to the Public Switched Telephone Network (30). When the Paging Unit (5) is powered-off, the Paging Server (27) sends a message to the Called Party Location Server indicating that the Paging Unit is active or unavailable, respectively. When the Paging Unit is to be paged, the PSTN (30) sends a message to the Paging Server (27), which then sends a radio message to Paging Unit (5) containing the data of the page.

Land-Line Telephone Station (7) is connected via Switch (32) to the Public Switched Telephone Network (30). The Switch (32) contains class of service information which causes a message to be sent to the called party location server when the land-line telephone station goes off-hook, or when the land-line telephone station sends a special request identified by a special telephone number for entry of special data into the called party location server. A voice mail server is connected to the Public Switched Telephone Network (PSTN) (30) to record messages when none of the called parties telephones are active, or when, for other reasons, the called party does not wish to accept a call.

FIG. 2 shows the same blocks as FIG. 1, with the addition of a Voice Announcement Store (52) and a Voice Server (50) for providing oral messages to a Calling Party (60). The Calling Party (60) is connected to the Public Switched Telephone Network which in accordance with data stored in the Called Party Location Server (20), routes the call appropriately to one of the destinations for that called party.

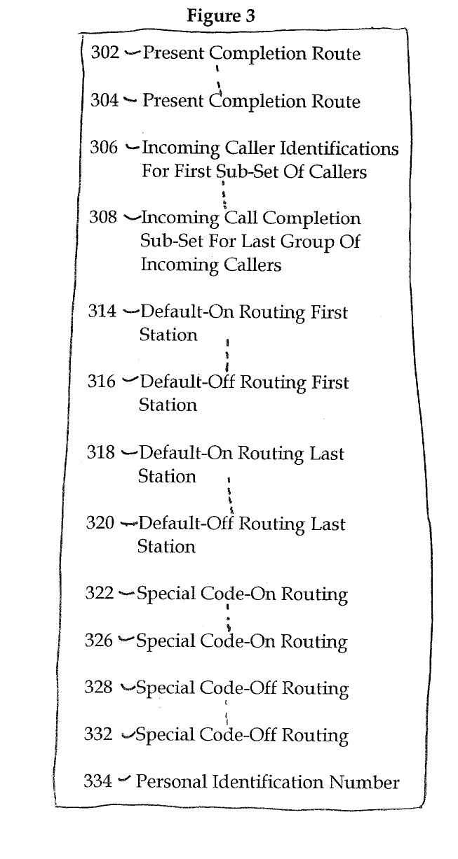

FIG. 3 shows the data stored for one called party. A plurality of entries (302), . . . , (304) represent the present completion data for each of a plurality of different types of calling parties. Locations (302), . . . , (304) are the identifications, e.g., telephone numbers or treatment, (e.g., voice mail), for each of N different classes of callers. These callers are identified by the data in blocks (306), . . . , (308). Blocks (314), (316); . . . , (318), (320) represent the treatment to be provided to messages indicating that a particular station has been powered-on or has originated a call for the default-on case, and that a particular station has been turned off, or that a special number indicating that a station is no longer to be treated as active has been received. The default-on entry for a mobile station might be that calls to the called number are automatically routed to the mobile station. A default-off treatment for a mobile station might be that the calls are to be sent to the home location at least until such a time as one of the other telephone stations becomes active. Block (322), . . . , (326) represents special treatment on the activation of a particular station when that station dials a particular code. A similar block (328), . . . , (332) is provided for another station. Finally, a Personal Identification Number is stored in Block (334). When a customer dials this personal identification number, that customer is given special treatment by routing the call to any available station. In one particular implementation, this can be done through group alerting so that all the stations of that customer are alerted simultaneously, and the call is completed to the first station that answers.

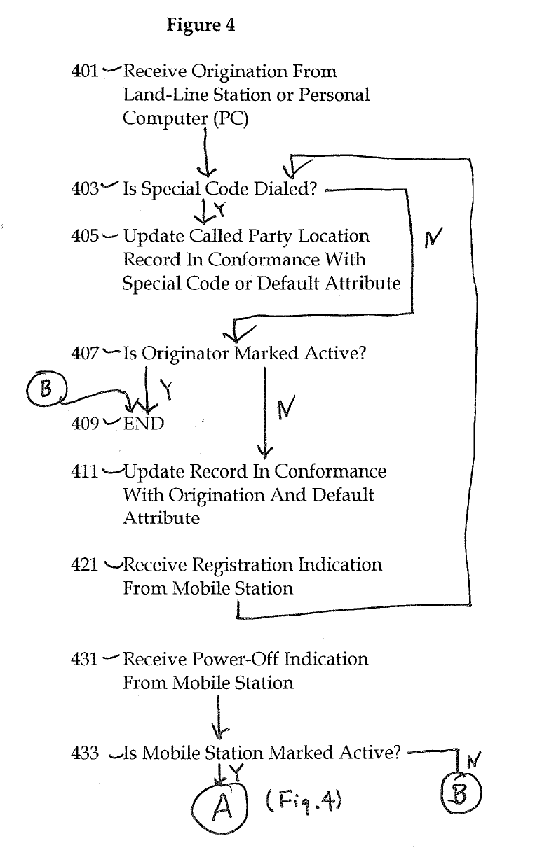

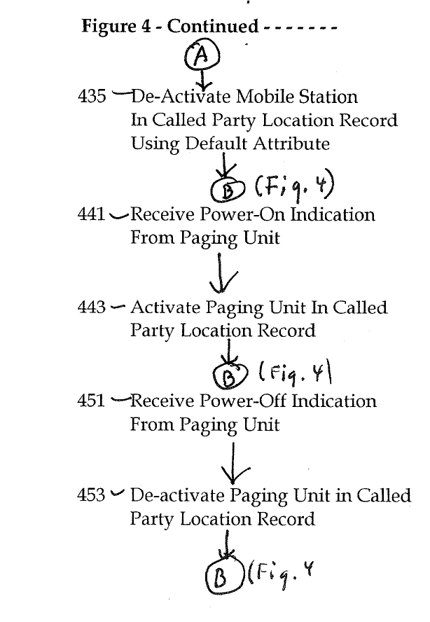

FIG. 4 is a flow diagram illustrating the process of altering entries in the record of the called party. This record is initially built up with all stations considered idle at the time the service is offered. Thereafter, an originating land-line or PC station originates a call, Action Block (401). Test (403) is used to determine whether at the time of origination, a special code is dialed. This special code might, for example, be a code indicating that for the purposes of completing terminating calls, this line should continue to be treated as unavailable. If a special code is dialed, then the record for the called party is updated in conformance with the special code, Action Block (405). If no special code is dialed, then Test (407), is used to determine whether the originator is marked “active”. If so, the record has already been updated to affect this activity, and End Block (409) is entered. If the originator has not been marked “active”, then the record is updated in conformance with the default attribute for activating a station.

If a register request is received from a mobile station, Action Block (421), then Test (403) is again entered to determine whether a special code has been dialed, and subsequent actions are taken as previously described. If a power-off message is received from a mobile station, Action Block (431), then Test (433) is used to determine whether the mobile station has been marked “active”. If not, indicating that from the point of view of the called party's location service, this mobile station is already inactive, and no further action needs to be performed on the data block of the called party's location server, so that End Block (409) can be entered. If the mobile station is marked “active”, then the mobile station is deactivated in the data block of the called party location service, using the default attribute, Action Block (435). Note that in this case, since power is being turned off, there is no need to check for a special code; a special code would have to be dialed prior to turning off the power. Following the execution of Action Block (435), End Block (409) is entered.

If a Paging Unit is powered-on, Action Block (441), then the Called Party Location Record is updated to reflect this change, Action Block (443). If a Paging Unit is powered-off, Action Block (451), then the Paging Unit is deactivated in the Called Party Location Record, Action Block (453).

The changes in the Called Party Location Record are accompanied by changes in the recorded message presented to a caller for cases in which the call is not answered. The solution of the appropriate message is part of the Called Party Location Record.

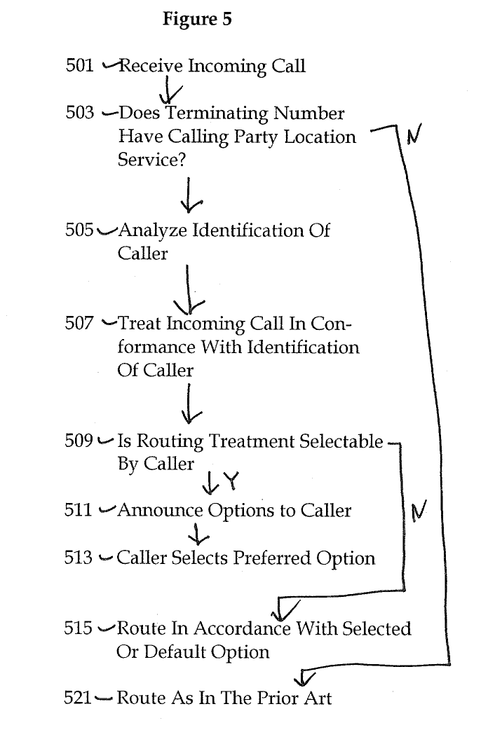

FIG. 5 illustrates the processing of an incoming call for the called party. An incoming call is received, Action Block (501). The identity of the called party is analyzed to determine whether that called party has calling party location service, Action Block (503). If not, the call is processed in conformance of the prior art, Action Block (521). If the called party does have called party location service, then the identity of the caller is analyzed, Action Block (505). The call is then treated in conformance with the data in the called party location server, and in conformance with the identity of the caller, Action Block (507). In some cases the caller may select from a menu of routing choices. Test (509) is used to detect such a situation. If no selection is provided, the call is routed in accordance with a default option provided by the called party location sewer database, Action Block (515). If selection is provided, the options are announced to the caller, Action Block (511). The caller selects a preferred option, Action Block (513). The system then routes the call in accordance with the selected option or a default option, Action Block (515).

The above description is of one preferred embodiment of Applicants' invention. Other embodiments will be apparent to those of ordinary skill in the art without departing from the scope of the invention. The invention is only limited by the attached Claims.

1. A method of completing a telecommunications call, comprising the steps of:
testing whether a called party has called party location service;
if said called party does not have called party location service, completing the call in conformance with the principles of the prior art;
if said called party has called party location service, accessing data for said called party location service; and
completing said call in conformance with data stored in said called party location service;
wherein said called party has at least one mobile station; and
wherein when said mobile station is powered-off, said called party location record is automatically updated to avoid attempting to complete to the mobile station which was powered-down.

2. The method of claim 1, wherein different calling parties are provided with different call routing arrangements for reaching said called party, having said called party location service;
wherein data is stored for identifying different subsets of calling parties; and
wherein different routing arrangements are stored for different subsets of said calling parties.

3. The method of claim 1, wherein a called party has a default routing change when a specific telephone station of said called party is activated or de-activated, and wherein alternate routing arrangements are triggered by a special code dialed by said called party.

4. The method of claim 1, wherein a routing arrangement has at least two options, which are announced to a caller, and in response to a signal from said caller, a specific routing arrangement is used for establishing a call from said caller.
